(19) United States
(12) Patent Application Publication
(10) Pub. No.: US 2007/0030135 A1
(43) Pub. Date: Feb. 8, 2007

(54) Inventions to keep people from driving a car without headlights: (illegal at night)

(76) Inventor: Richard Croxton Taylor, Virginia Beach, VA (US)

Correspondence Address: Richard C. Taylor, Apt. 103, 1000 Autumn Woods Ln., Virginia Beach, VA, 23454, US

(21) Appl. No.: 11/195,553

(22) Filed: Aug. 3, 2005

(51) Int. Cl. B60Q 11/00

(52) U.S. Cl. 340/458

(57) ABSTRACT

(OLD SITUATION) If yours or someone elses car headlights are not shining you may drive down the highway at night (or a rainy night) and find your car colliding into another car.

(NEW SITUATION) With more headlights shining you are much less likely to experience that undesirable situation.

### CROSS-REFERENCE TO RELATED APPLICATIONS

I have noticed that there is such a thing as a warning buzzard if the turn signal lights don't work.

### STATEMENT REGARDING FEDERALLY SPONSORED RESEARCH AND DEVELOPMENT

Not Applicable

### REFERENCE TO SEQUENCE LISTING, A TABLE, OR COMPUTER PROGRAM LISTING COMPACT DISC APPENDIX

Not Applicable

### BACKGROUND OF THE INVENTION

This invention involves highway safety, specifically the making of safer cars.

I hope to make sure that cars and trucks always drive with; not without headlights at night. Even the driver who always seems to turn his headlights on; might inadvertently not turn them on. Also, there are a number of drivers who carelessly don't turn on their headlights.

I almost had an accident because of headlights. If you start off from a well lit gas station; all of those lights make it difficult to notice by looking beyond the front of the car if the headlights are on. Then travel onto a street with a lot of street lights (glare), and it is again difficult to tell by looking beyond the front of the car if the headlights are on especially if it is raining. With all that rain, other cars may not see your car if only your parking lights are on.

At night you can't tell from the car dashboard meters and gauges if the situation exist where the headlights are off, and only the parking lights are on. See invention #3.

### BRIEF SUMMARY OF THE INVENTION

My inventions endeaver to keep car headlights on one way or another.

### BRIEF DESCRIPTION OF THE SEVERAL VIEWS OF THE DRAWING

Not Applicable

### DETAILED DESCRIPTION OF THE INVENTION

invention 1 A car that has parking lights and headlights that shine whenever the engine is running. And a lights not working warning light, buzzard or voice.

Note; Currently at night you can't tell if the headlights and parking lights are on, or if only the parking lights are on because the dashboard including the speedometer is lit up similarly in both cases.
Inventions 2&3 tend to correct the problem.

invention 2 A car with a switch which turns on the parking lights and part of the dashboard illumination of the speedometer, meters and gauges; and another switch which turns on the headlights and the rest of the dashboard illumination of the speedometer, meters and gauges.

invention 3 A car with a warning light, buzzard or voice which indicates that the headlights are not on while the parking lights may be on.

invention 4 A car equipped with a dashboard clock that auto-switches the headlights and parking lights on and off at a certain time.

Dust and dawn occur at a time which is approxi-3 minutes different from the previous day. So a smart enough clock would be able to switch the lights on at dusk and off at dawn each day. The clock could switch the lights on for the driver whose trip begins at night. This car could have a manual light switch too for daylight rainstorms. And a warning light, buzzard or voice in case this mechanism fails.

What I claim as my inventions are:

1. Cars that have headlights and parking lights which shine whenever the engine is running (& a lights out warning buzzard, light or voice).

2. Cars with a switch which turns on the parking lights and part of the dashboard illumination of the speedometer, meters and gauges; and another switch which turns on the headlights and the rest of the dashboard illumination of the speedometer, meters and gauges.

3. Cars with warning buzzards, lights or voices to let you know if only the parking lights are on, and not the headlights and the parking lights.

4. Cars which automatically turn on the parking lights and the headlights. (& a mechanism not working warning light buzzard or voice)
